(19) United States
(12) Patent Application Publication
(10) Pub. No.: US 2003/0206572 A1
(43) Pub. Date: Nov. 6, 2003

(54) Method and device for determining the temperature of a cooking vessel

(76) Inventors: Ralf Dorwarth, Oberderdingen (DE); Martin Baier, Ettlingen (DE)

Correspondence Address: J. Rodman Steele, Jr., Akerman, Senterfitt & Eidson, P.A., Post Office Box 3188, West Palm Beach, FL, 33402-3188, US

(21) Appl. No.: 10/033,875

(22) Filed: Dec. 19, 2001

(30) Foreign Application Priority Data
Dec. 21, 2000 (DE) 10064621.2

(51) Int. Cl. G01K 1/14; G01K 13/00; G01J 5/02

(52) U.S. Cl. 374/121; 374/141

(57) ABSTRACT

A description is given of a device and a method for determining the temperature of a cooking vessel placed on a hotplate of a heating appliance, e.g. on the glass ceramic plate of an inductive cooker, in the vicinity of a heating zone. In the vicinity of the heating zone is applied to the top of the hotplate at least one flat measuring element, e.g. formed by a colour coating and whose top surface comes into flat contact with the cooking vessel bottom on setting down the cooking vessel. As a result the temperature of the measuring element, by heat conduction, reliably matches the cooking vessel temperature, so that by determining the measuring element temperature it is possible to determine the cooking vessel temperature. The measuring element can serve as a reference measuring surface for infrared temperature measurement through the hotplate, the precision of the temperature measurement not being dependent on the emission capacity of the set down cooking vessel.

### FIELD OF USE AND PRIOR ART

The invention relates to a method and to a device for determining the temperature of a cooking vessel. The cooking vessel is placed on a heating or hotplate, particularly a glass ceramic plate, of a preferably electrically operated heating appliance on or in the vicinity of a heating zone of said heating appliance.

For heating food and the like during cooking, roasting, frying, etc., nowadays use is frequently made of heating appliances which generally have hotplates made from a glass ceramic material and on which are defined one or more cooking or heating zones, which can in each case be heated by heating devices positioned below the hotplate. The heating devices can e.g. be constructed in the form of electric radiant heaters or in the form of induction devices with one or more induction coils for the inductive heating of the cooking vessels placed on the associated cooking zone.

In most conventional cookers a cooking process is controlled in that by means of a control element associated with the cooking zone a power stage of the latter suitable for the desired cooking process is preset and the cooking process can then be monitored by one operator. The quality of the cooking result is significantly dependent on the experience of the operator and as a rule no precise determination of the temperature of the cooking vessel or the food contained therein is carried out.

Automatic cooking systems have also been proposed, which permit a more or less precise temperature determination of the cooking vessels, e.g. in order to allow an automatic cooking controlled by the temperature determination process. In one known system special cooking vessels are used, in which a black colour marking is applied laterally and just above the cooking vessel base surface. Through an infrared sensor directed from the side onto said colour marking, the radiation spectrum emitted by said marking can be determined and from it can be derived the cooking vessel temperature. The measured value can be used for controlling the heating device associated with the cooking zone, so that e.g. in the case of overheating the heat output of the associated heating device can be lowered or the cooking unit can be switched off. The cooking system requires special cooking vessels provided with corresponding colour markings. If the colour markings are not used, the problem arises that the surface areas of the cooking vessel observed with respect to their heat radiation differ as regards structure and colour, so that the surface emission capacity can change in an uncontrollable manner, which leads to an imprecise measurement. Moreover, as a result of the lateral cooking vessel observation, there are generally limitations regarding the setting down and handling of the cooking vessels placed on the hotplate.

### PROBLEM AND SOLUTION

The problem of the invention is to provide a method and a device for determining the temperature of cooking vessels placed on hotplates and avoiding the disadvantages of the prior art. In particular, a precise determination of the temperature is to be made possible without any limitations concerning the handling of the cooking vessels.

For solving this problem the invention proposes a device having the features of claims 1 and 18 and a method having the features of claim 20. Preferred further developments are given in the dependent claims. By explicit reference the wording of all the claims is made into a part of the content of the description.

According to the invention in the vicinity of a heating zone to be monitored on the top of the hotplate facing the cooking vessel set down is provided at least one flat measuring element, which has a top surface facing the bottom of a cooking vessel to be set down and intended for contact with the bottom of the cooking vessel and whose surface area normally corresponds to a fraction of the total surface area of the associated heating zone. The temperature of this measuring element is determined and generally there is at least one sensor for determining the temperature of the measuring element. As the measuring element is constructed in such a way that the normally largely planar or slightly convex bottom of a set down cooking vessel is pressed in large area manner onto the measuring element under the action of the weight of said vessel, the measuring element temperature is generally rapidly adjusted to the cooking vessel bottom temperature due to heat conduction. In order to ensure a rapid and reliable temperature compensation, the measuring element is appropriately made from a good heat conducting material and has a low heat capacity. In addition, a certain wear, abrasion or scratch resistance is advantageous, so that even after operation for many years there is no need to fear functional deteriorations caused by wear. Through the provision in the vicinity of the heating zone of at least one measuring element having clearly defined characteristics, a precise temperature measurement on the cooking vessel is made possible, for as long as it is set down in such a way as to ensure an adequate contact with the measuring element. In this case the measurement can be largely independent of other characteristics of the cooking vessel, e.g. the heat radiation capacity of its surface. As a result of the measuring elements according to the invention largely standardized measurement points for the precise determination of the cooking vessel temperature are created in the bottom region of the cooking vessel.

Particular preference is given to further developments in which the determination of the measuring element temperature takes place from below through the hotplate. This makes it possible to house temperature determination devices of the externally positioned measuring elements, e.g. in a substantially hermetically sealed area below the glass ceramic plate of a hob in a protected manner. There is no need for lines, cables or the like, which on the plate top lead to the measuring element. For example, directly below a measuring element, a measuring resistor element can be applied, e.g. by printing, to the inside of the hotplate enabling the measuring element temperature to be determined, whilst utilizing the heat conduction through the hotplate. However, in particular below the hotplate and optionally spaced therefrom, can be positioned at least one infrared sensor with the aid of which the temperature of the hotplate-facing underside of the measuring element can be determined. The hotplate material should in this case have an adequate transmission for the heat radiation used for the measurement. As the underside of the measuring element, independently of the cooking vessel characteristics, has a defined emission capacity for heat radiation determined by the nature of the measuring element and optionally the hotplate surface, such a system can operate precisely with any cooking vessel type, without special precautions being necessary on the cooking vessel to ensure a specific radiation capacity. Thus, users of such systems can utilize the advantages of a temperature measurement by using infrared sensors, without being involved in capital expenditure in obtaining cooking vessels.

A measuring element can e.g. be formed by a material coating applied in self-adhesive manner to the top of the hotplate, e.g. by a material coating, particularly a heat resistant dye or ink or colour coating applied by a thin or thick film process. This brings about a particularly good adhesion of the measuring element to the top of the hotplate and in addition the shape and/or thickness of the measuring element can easily be adapted to the desired measuring element design by controlling the process during coating. For example, suitable colour coatings can be used, such as are employed in the conventional decoration of glass ceramic surfaces. Application can take place in the same process step. If necessary, metal particles can be admixed.

It is alternatively or additionally possible for at least one measuring element to be formed by a separate material portion, e.g. a piece of metal foil, which can be fixed with the aid of suitable fixing means, e.g. by bonding, to the top of the hotplate. Particularly in the case of an infrared temperature measurement from the underside of the hotplate an adequate emission capacity and/or heat radiation transparency of the adhesive material must be ensured.

To ensure an adequate, very large surface area contact between the measuring element and the underside of the cooking vessel, it is appropriate for the top of the measuring element to project slightly over the top of the hotplate, i.e. is raised compared with the hotplate top. Preference is given to small projections of less than approximately 0.2 mm, in order to keep small the height of an optionally occurring air gap between the top of the hotplate and the underside of the cooking vessel. Appropriately the projections are between approximately 0.05 and approximately 0.2 mm, being in particular approximately 0.1 mm.

It can also be appropriate to provide in the vicinity of the cooking zone several mutually laterally spaced measuring elements, which ensures that also in the case of cooking vessel sizes not ideally suited to the cooking zone size, in each case at least one measuring element provides precise temperature measurement values. It is preferable to have a triangular arrangement of three normally identical measuring elements ensuring that a cooking vessel is supported in stable manner with an adequate base surface on three points and cannot wobble. In order to avoid that a set down pot, saucepan, etc., during stirring does not turn around a support surface formed by a measuring element, it is advantageous if there is no measuring element in the central area of the heating zone. Generally an arrangement of several measuring elements over a circle is advantageous and the diameter thereof is slightly smaller or roughly the same as the diameter of typical cooking vessels to be placed on the corresponding heating zone, so that a support is ensured in the outer marginal area of a cooking vessel bottom.

The invention, which in the case of preferred embodiments proposes one or more reference measuring surfaces for infrared temperature measurement from the inside of a glass ceramic hob, also relates to heating appliances, which are equipped with a temperature determination device according to the invention and in particular electric heating appliances. It is particularly advantageous for use with induction cooking units, where the heat for heating set down cooking vessels is provided in the wall material of the actual cooking vessel, particularly in the cooking vessel bottom, by inductively generated eddy currents. Particularly in the case of such electric heating appliances the precise determination of the cooking vessel temperature is useful, because an indirect temperature monitoring, e.g. by monitoring the hotplate temperature, can be imprecise, because there may be large temperature differences between the hotplate and the cooking vessel. Inductive cooking systems are particularly suitable compared with also possible radiant heating systems, because with the latter normally the at least one measuring element is directly heated from below by heat radiation, so that possibly there can be differences compared with the cooking vessel temperature. With inductive cooking systems it is generally easier to install below the hotplate, e.g. in the vicinity of an induction coil, one or more heat-sensitive infrared sensors in a protected manner, because in this area, compared with radiant heating systems, normally much lower temperatures prevail, which can improve the operation and life of the infrared sensors.

In addition, with inductive systems the hotplate material can be selected in such a way that it can in particular be in the range of typical saucepan bottom temperatures, which normally during cooking are below approximately 140° C. and e.g. during frying are max. 250 to 300° C., for which the corresponding heat radiation is particularly transparent. A transmission capacity at higher temperatures, i.e. shorter wavelengths of the heat radiation, such as is e.g. necessary for glass ceramic plates in radiant heating systems, is not absolutely necessary, so that with respect to its transmission characteristics the hotplate material can be matched in optimum manner to the requirements during temperature determination.

These and further features can be gathered from the claims, description and drawings and the individual features, both singly or in random combination, can be implemented in an embodiment of the invention and in other fields and can represent advantageous, independently protectable constructions.

### BRIEF DESCRIPTION OF THE DRAWINGS

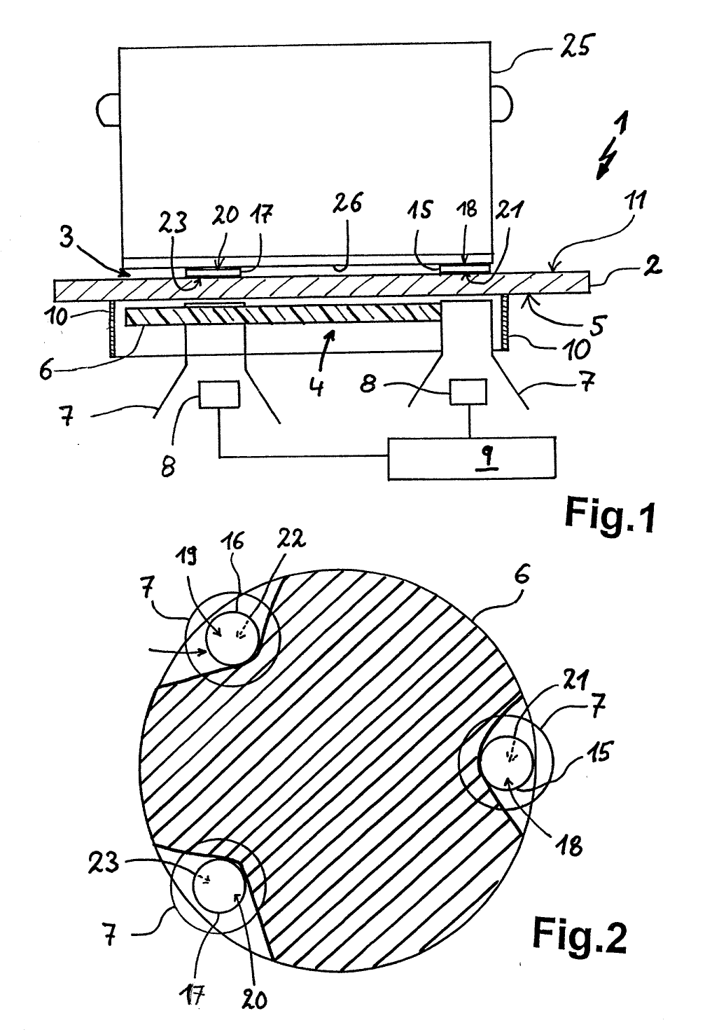

An embodiment of the invention is shown in the drawings and is explained in greater detail hereinafter. FIG. 1 diagrammatically shows a preferred embodiment of a temperature determination device according to the invention, which is installed in an induction cooking unit. FIG. 2 is a plan view of the induction cooking unit of FIG. 1.

### DETAILED DESCRIPTION OF AN EMBODIMENT

The diagrammatic vertical section of FIG. 1 is a detail of an electric cooker 1, whose top or working surface is defined by a horizontal glass ceramic plate 2, which can have one or several, mutually spaced cooking units or cooking or heating zones 3. The heating devices 4 provided for the individual heating zones are positioned facing the inside or underside 5 of the plate 2 and in the inductive electric heating appliance shown are formed in the represented embodiment by multiturn, planar induction coils 6, which are in each case fixed with a limited spacing below the glass ceramic plate 2. The exemplified induction coil 6 is connected to a not shown high frequency generator of the cooking appliance. In the radially outer area of the planar induction coil 6 are fixed in the area facing the plate thereof cylindrical and funnel-shaped, downwardly widening heat shields 7, which ensure that in the interior and below the shield 7 the electromagnetic alternating field generated by the coil 6 is significantly attenuated and heat radiating downwards from the area of plate 2 is largely shielded.

In the shielded area and with visual contact to the plate underside 5 are provided diagrammatically represented infrared sensors 8, e.g. with an infrared-sensitive diode, which are connected to an evaluation electronics 9 for processing the voltage signals provided by the infrared sensors. The evaluation electronics 9 can be placed on a printed circuit board, which is fixed in the hermetically sealed area below the glass ceramic plate 2 and which carries the electronic components of an electronic control device for the electrical appliance 1.

The shape and size of the heating zone 3, in the embodiment circuit heating zone, associated with the induction coil 6, is defined in the interior of the hob by a ring 10 surrounding with radial spacing the induction coil and extending to the underside 5 of the glass ceramic plate 2 and which can be made from an electrically conductive material, e.g. aluminium, shielding the electromagnetic radiation of coil 2. On the planar top surface 11 of the approximately one centimetre thick, plane-parallel hotplate 2, the outer boundary of the circular heating zone 3 can be marked by a not shown ring of printed-on decorative ink or colour, so that a user can set down the cooking vessels in the correct location, which should be as central as possible. In the case of hotplates made from a material transparent to light in the visible spectrum, the border of the cooking zone can be detected in this case by a ring 10 visible from above.

In the interior of the heating zone 3, three flat, circular colour coating areas 15, 16, 17 are applied to the hotplate top 11 and their diameter is in each case a fraction, e.g. approximately one tenth of the cooking zone diameter. The colour coating circles can e.g. be applied by the thin or thick film procedure, e.g. by printing and have typical thicknesses of approximately 0.1 mm, so that the largely planar top surfaces 18, 19, 20 of the colour circles are uniformly raised compared with the plate top 11. With their undersides 21, 22, 23 the colour coatings adhere firmly to the plate top 11. The centres of the colour circles 16, 17 are equidistantly spaced on a circle, whose diameter can be approximately 10 to 30% smaller than the cooking zone diameter. As a result the raised colour coatings form a triangular arrangement on which can be placed in a stable, wobble-free manner a cooking vessel 25 whose size is adapted to that of the cooking zone 3. If the cooking vessel 25 is set down in a more or less central manner in the vicinity of the cooking zone, the substantially planar or slightly spherically curved cooking vessel bottom 26 is in contact with the tops 18, 19, 20 of the colour points 15, 16, 17 in each case substantially over the entire surface, so that under the weight of the cooking vessel and the food therein, it is possible to ensure a flat pressure contact between the colour coating elements 15, 16, 17 and the cooking vessel underside 26.

The colour coating circles 15, 16, 17 applicable in reliably adhering and inexpensive manner form measuring elements of a temperature determination device making it possible to reliably and precisely determine the temperature of the cooking vessel, particularly the cooking vessel bottom 26, in an inexpensive manner. For this purpose at least one of the measuring elements 15, 16, 17 with respect to the infrared sensor 8 located below the plate 2, is positioned in such a way that the underside of the measuring element in contact with the plate top 11 is in a visible connection with the infrared sensor 8. Alternatively to the direct visual connection, it is possible to create a heat radiation-conducting connection between the infrared sensor and measuring element underside using one or more mirrors suitable for reflecting infrared radiation and/or with the aid of heat radiation-conducting light-conducting fibres.

If a pot or the like is now placed on the measuring elements 15, 16, 17 and heated by switching on the induction heating system, as a result of the appropriately high thermal conductivity and low heat capacity of the measuring elements and due to the large area pressure contact between the bottom of the pot and the measuring elements, the undersides of the measuring elements, with an only limited time lag, largely assume the temperature of the pot bottom area in contact with the particular measuring element. A particular advantage of the invention that this temperature largely corresponding to the pot bottom temperature is present on a reference surface precisely defined with regards to its emission characteristics, namely on the measuring element underside 21, 22, 23 in contact with the hotplate top. As a result it is possible with the aid of the infrared sensor 8 to carry out from below through the infrared-transparent plate 2 a very precise temperature measurement, because differences in the radiation capacity of different cooking vessel bottoms has little or no effect with such a temperature measurement. The measurement result of this temperature measurement method is consequently substantially independent of the emission capacity of the pot bottom, so that it is possible to use cooking vessels having random surface characteristics without impairing the temperature measurement, provided that the pot bottom shape permits an adequately large area contact with the measuring element used for the measurement. This contact is appropriately ensured in such a way that the measuring element, by heat conduction, rapidly matches the pot bottom temperature.

As the invention makes it possible to relatively precisely in time-near manner to determine the pot bottom temperature or the bottom temperature of other cooking vessels, a temperature measurement according to the invention is particularly suitable for automatic, sensor-assisted cooking systems, in which the heat capacity of the heating devices associated with the cooking zones can be controlled as a function of the cooking vessel or food temperature. The determined temperature can also be at intervals displayed, so that an operator can carry out an effective and appropriate cooking, roasting, frying, etc. of the food in question.

1. Device for determining the temperature of a cooking vessel, said cooking vessel having an underside and with said underside being placed on a hotplate of a heating appliance, on said hotplate being defined at least one heating zone and said cooking vessel being placed on said heating zone, wherein:
at least one flat measuring element is provided
said flat measuring element having a top surface for contact with said underside of said cooking vessel
said flat measuring element being placed on the top of said hotplate
a device being provided for determining the temperature of said measuring element.

2. Device according to claim 1, wherein said device being provided for determining the temperature of said measuring element is at least one sensor, said sensor being placed below said hotplate.

3. Device according to claim 2, wherein said device for determining the temperature of said measuring element is an infrared sensor.

4. Device according to claim 1, wherein at least one said measuring element is formed by a material coating applied in self-adhesive manner to said top of said hotplate.

5. Device according to claim 4, wherein said material coating is being constituted by a printed-on colour coating.

6. Device according to claim 1, wherein at least one said measuring element is formed by a separate and thin material portion being fixed to said top of said hotplate.

7. Device according to claim 6, wherein said measuring element is a metal foil.

8. Device according to claim 6, wherein said measuring element is bonded to said top of said hotplate.

9. Device according to claim 1, wherein said top surface of said measuring element projects slightly over said top of said hotplate.

10. Device according to claim 9, wherein said top surface of said measuring element projects between 0.05 and 0.15 mm over said top of said hotplate.

11. Device according to claim 1, wherein in said vicinity of said heating zone are provided several measuring elements.

12. Device according to claim 11, wherein in said vicinity of said heating zone are provided three said measuring elements in a triangular arrangement.

13. Device according to claim 1, wherein said cooking zone has a centre and at least one said measuring element is positioned eccentrically to said centre..

14. Device according to claim 1, wherein said cooking zone has a centre and none said measuring element is positioned in said centre.

15. Device according to claim 1, wherein said measuring element is at least partially made of a good heat conducting material with a low heat capacity.

16. Device according to claim 1, wherein said hotplate is at least partially made of a material with a good radiation transparency for infrared radiation, said infrared radiation at least ranging from a colour temperature range between room temperature and approximately 250 to 300° C.

17. Device according to claim 1, wherein said heating zone is heated by an induction heating device, said induction heating device having at least one induction coil.

18. Electric heating appliance with a hotplate, on said hotplate being defined at least one heating zone, said heating zone being heatable by a heating device, said heating device being positioned below said hotplate, said electric heating appliance further including a device for determining the temperature of a cooking vessel being placed on said heating zone, wherein said device for determining the temperature of said cooking vessel is constructed in accordance with claim 1.

19. Electric heating appliance according to claim 18, wherein said heating device is an induction heating device, said induction heating device including at least one induction coil.

20. Method for determining the temperature of a cooking vessel being placed on a hotplate of a heating appliance, on said hotplate being defined at least one heating zone, said cooking vessel having an underside and with said underside being placed on said heating zone, wherein the following steps are provided:
provision of at least one flat measuring element on said heating zone for contact with said underside of said cooking vessel, said flat measuring element having a top surface
setting down said cooking vessel on said heating zone in such a way that said underside of said cooking vessel comes into contact with said top of said measuring element,
determination of the temperature of said measuring element.

21. Method according to claim 20, wherein said temperature of said measuring element is being measured from below and through said hotplate.

22. Method according to claim 21, wherein said measuring element has an underside, said underside emitting heat radiation, said heat radiation being emitted through said hotplate, said heat radiation being measured and from this said temperature of said measuring element is being determined.
